(19) United States
(12) Patent Application Publication
(10) Pub. No.: US 2013/0125814 A1
(43) Pub. Date: May 23, 2013

(54) Painting System Operating in Recirculating Air Mode

(71) Applicants: Michael Schlipf, Goeppingen (DE); Detlef Heiland, Schoeningen (DE)

(72) Inventors: Michael Schlipf, Goeppingen (DE); Detlef Heiland, Schoeningen (DE)

(73) Assignee: EISENMANN AG, Boeblingen (DE)

(21) Appl. No.: 13/807,433

(22) PCT Filed: Jul. 28, 2011
(86) PCT No.: PCT/EP2011/003795

§ 371 Date: Dec. 28, 2012

(30) Foreign Application Priority Data
Aug. 6, 2010 (DE) 10 2010 033 711.0

(51) Int. Cl. B05B 15/12

(52) U.S. Cl. CPC B05B 15/1229
USPC 118/712; 118/610

(57) ABSTRACT

A painting system operating in recirculating air mode, comprising a spray booth (1) which has from the top downwards an air plenum (2), a painting zone (3) and a wash-out (4). The recirculating air flowing through the painting zone (3) picks up overspray particles which are largely removed again from the recirculating air in the wash-out (4) with the aid of a stream of water. The recirculating air passes through a conditioning unit (21) before said air is returned to the air plenum (2) of the painting booth (1). The conditioning unit (21) comprises at least one capacitor (29) and/or a droplet separator (30), with the aid of which a liquid can be recovered from the recirculated air. Said liquid is fed to a supply source (24, 25) for flushing liquid. The flushing liquid is used for cleaning the application equipment in the painting zone (3).

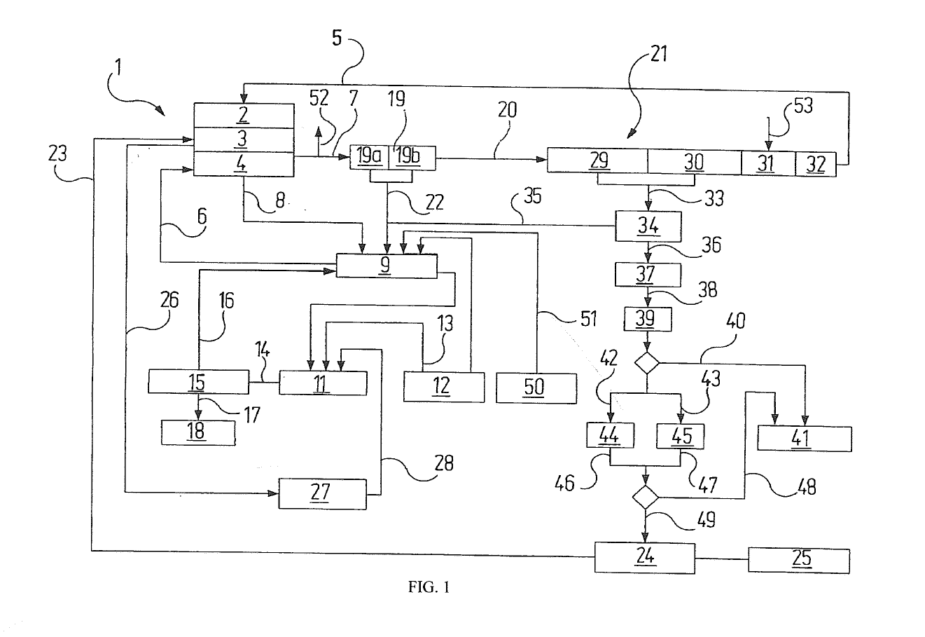

The invention relates to a painting system which operates in recirculating air mode, in particular for painting vehicle attachment parts or vehicle bodies, having
a) a spray booth which, from the top downwards, includes:
   aa) an air plenum to which conditioned recirculating air may be fed;
   ab) a painting region in which at least one application device for applying the paint is provided and through which recirculating air may flow and in so doing takes up and carries along particles of paint overspray;
   ac) a scrubbing unit in which the recirculating air coming from the painting region and laden with particles of paint overspray interacts with a stream of water and in so doing is at least partly freed of particles of paint overspray;
b) a conditioning unit which lies in the circulation path of the recirculating air and contains at least a condenser and/or a droplet separator, wherein the liquid obtained from the condenser and/or the droplet separator may be returned to the painting system.

Painting systems of this kind which operate in recirculating air mode generally have automatic booths, that is to say booths that are equipped with flat spraying machines or robots for guiding the application device. The recirculating air which is guided through the painting region and the scrubbing unit gains a very high proportion of water in the latter and so, to be capable of being reintroduced into the painting region of the spray booth again, water must be removed from it. This is done by means of a conditioning unit which contains at least a condenser and/or a droplet separator. Other components of the conditioning unit may be heating devices and/or filters, though these are not relevant in the present context.

In order to keep the overall water consumption of the painting system as low as possible, until now part of the liquid obtained from the conditioning unit, or to be more precise the condenser or the droplet separator located there, is returned to the system. In known painting systems of the type mentioned at the outset, this is done by introducing this liquid into the system tank in which the water that flows through the scrubbing unit is temporarily stored. During circulation, this water which is temporarily stored in the system tank is enriched with various chemicals and paint constituents by the scrubbing process and so has regularly to be regenerated. How this is done is not relevant in the present context. It should merely be pointed out here that in the present context the term “water” is understood not as pure water but water to which chemicals are added.

In automatic booths, in particular, a change of colour is frequently performed. Every time the colour is changed it is necessary for all the components of the system, in particular the application devices, which have come into contact with the colour used previously to be cleaned carefully before operation with the new colour can begin. A special rinsing liquid is used for this purpose.

The object of the present invention is to construct a painting system of the kind mentioned at the outset such that operation can be made less expensive overall while water management is further improved.

This object is achieved according to the invention in that
d) at least some of the liquid obtained from the condenser and/or the droplet separator may be fed to the supply source for rinsing liquid.

In the present invention, it has been recognised that liquid obtained from the conditioning unit contains a considerable amount of chemicals whereof the disposal by way of the system tank results in relatively high expense in terms of coagulants, detackifier and polyelectrolytes, which makes the system operating costs dearer. At the same time, it has been recognised that the chemicals in this liquid may well be useful if they are made available for producing the rinsing liquid which is used in particular to clean the application device when changing colour. It is thus possible to save on the costs of chemicals at this point.

The chemicals in question are for example butyl glycol, butyl diglycol, butanol, relatively long-chain alcohols, aminoethanols and surface-active substances.

Advantageously, the supply source for rinsing liquid includes a preparation vessel, to which the liquid obtained from the condenser and/or the droplet separator may be fed, and a reserve container for an aqueous rinsing concentrate. The concentration of chemicals in the liquid taken from the conditioning unit is not constant over time, with the result that the quantity of aqueous rinsing concentrate required in each case for the correct interaction of the rinsing liquid can be metered into the preparation vessel from the reserve container for the aqueous rinsing concentrate.

In general, the liquid obtained from the condenser and/or the droplet separator may not be fed directly to the supply source for rinsing liquid. It may well still contain a considerable amount of solids which could result in incompatibilities in the application devices and the resulting paint work. For this reason, an embodiment of the invention in which a filter is provided through which liquid obtained from the condenser and/or the droplet separator may flow is recommended.

Nor does the fact that the liquid taken from the conditioning unit is free of relatively large solid particles ensure beyond any doubt that this liquid is suitable for use in the rinsing liquid. There are substances which are quite capable of passing through filters but which could result in disruptions to the operation of the painting system or problems in the paint work if they get into the rinsing liquid. For this reason, in a particularly preferred embodiment of the invention, a test station is provided which, by measuring the conductivity and/or refractive index and/or turbidity of the liquid obtained from the condenser and/or the droplet separator, checks its suitability for re-use in the rinsing liquid. An additional batchwise check for disruptions to paint wetting may be carried out where necessary. Unsuitable liquid is fed to a reserve container. This less valuable portion of the liquid may also be used in the system, albeit not as a rinsing liquid but for example as a cleaning liquid for cleaning parts of the system, such as the walls in the spray booth and/or the gratings and/or the walls in the scrubbing unit and/or the drainage channels, during interruptions in operation.

Advantageously, at least two parallel storage containers are provided, in which liquids coming from the condenser and/or the droplet separator may selectively be temporarily stored before they are fed to the supply source for rinsing liquid. Here, the procedure is such that first one of the two storage containers is filled. Once this rinsing procedure is complete, a certain concentration of chemicals prevails in the liquid in the storage container. If this liquid is now taken from the first storage container to the preparation vessel for the supply source of the rinsing liquid, then a suitable quantity of aqueous rinsing concentrate may be metered in from the corresponding reserve container, in a manner adapted to this concentration of chemicals. While the liquid is being drawn off from the first storage container, the second storage container parallel thereto is filled. Once this is full, in general a different concentration of chemicals will prevail in the liquid stored there, and this requires a different metering of aqueous rinsing concentrate when it is put into the supply source for rinsing liquid.

An exemplary embodiment of the invention will be explained in more detail below with reference to the drawing; the single FIGURE shows schematically a system which operates in recirculating air mode, for painting vehicle attachment parts.

The system illustrated in the drawing includes as the main component a spray booth which is designated overall by the reference numeral 1 and whereof the basic construction is known. Visible in the drawing, from the top downwards, are an air plenum with filter ceiling 2, a painting region 3 in which there are arranged flat spraying machines or robots, not generally illustrated, which guide application devices during the painting procedure. The vehicle attachment parts are guided through the painting region 3 by means of a suitable transport system. The painting region 3 communicates with a scrubbing unit 4, located underneath, by way of an opening which has a large surface area and is covered by a grating which can be walked on.

A recirculating air flow passes through the entire spray booth 1 from the top downwards and is fed by way of a line 5 first to the air plenum 2 and is then introduced into the painting region 3 by way of the filter ceiling which downwardly delimits the air plenum 2. In the painting region 3, it takes up the overspray produced during the painting procedure—that is to say particles of paint that have not adhered to the vehicle attachment parts—and transports them to the scrubbing unit 4. In the scrubbing unit 4, which frequently takes the form of a so-called venturi scrubber, the paint particles are removed from the recirculating air by scrubbing with the aid of a stream of water fed by way of a line 6. Once the recirculating air leaves the scrubbing unit 4 by way of the line 7 it is largely free of paint particles. The water charged with paint particles is removed from the scrubbing unit 4 by way of the line 8 and fed to a system tank 9.

Two lines go from the system tank 9, namely on the one hand the line 6 already mentioned above, which leads to the scrubbing unit 4 in the spray booth 1, and a further line 10 which is connected to a decanter storage container 11. There, a coagulant and separating agent which is introduced from a corresponding reserve container 12 by way of a line 13 is added to the water.

From the decanter storage container 11, the water laden with paint particles passes by way of a line 14 into a decanter 15. There, as the name “decanter” indicates, the paint particles are separated from the water with the aid of a decanting procedure, forming a sludge. The water which has been largely freed of paint particles passes by way of a line 16 back to the system tank 9, while the paint sludge is fed by way of a line 17 to a disposal container 18.

A further reserve container 50 for coagulant and separating agent is directly connected to the system tank 9 by way of a line 51. The agent metered into the decanter storage container 11 must be at least flocculating; the agent metered directly into the system tank 9 must be at least detackifying.

The recirculating air which leaves the spray booth 1 by way of the line 7, and which is largely freed of paint particles in the scrubbing unit 4, is in this exemplary embodiment first of all fed to a two-stage filtration unit 19 and then by way of a line 20 to a conditioning unit, designated as a whole by the reference numeral 21 and described in more detail below. In this conditioning unit 21 the recirculating air is prepared such that it may be circulated to the spray booth 1 once again, by way of the line 5 already mentioned above.

Paint particles are removed from the recirculating air in the filter 19a of the filtration unit 19, and paint droplets are removed in the filter 19b. Both these are returned to the system tank 9 by way of a line 22.

An exhaust air line 52 that leads to the surrounding atmosphere branches off from the line 5; fresh air may be fed in by way of a line 53 in the region of the conditioning unit 21. In this way, where necessary it is possible to change over from a fully recirculating air mode to a fresh/exhaust air mode during maintenance work, or to a mixed mode in order to reduce solvent content in the surrounding air, in order to avoid the risk of explosion.

So far, substantially two media that are used in the painting system have been mentioned, namely the recirculating air, which flows through the spray booth 1 from the top downwards, and the water, which is used in the scrubbing unit 4 for (largely) freeing the recirculating air from paint particles. In painting systems of this kind, however, a further medium is also used, namely a rinsing liquid, which will be discussed in more detail below.

In painting systems of the type concerned here, that is to say normally in automatic booths in the spray booths whereof flat spraying machines or robots for guiding the application devices are arranged, the colour is often changed. Before there is a change from one colour of the paint used to another, in particular the application devices have to be cleaned of the last paint used. For this purpose, the above-mentioned rinsing liquid is used and is fed by way of the line 23 into the painting region 3 of the spray booth 1, and in particular to the application devices there. This rinsing liquid comes from a preparation vessel 24 of a supply source 24, 25, wherein the preparation vessel is moreover stirred and may be charged with an aqueous rinsing concentrate, which has to be diluted, from a reserve container 25.

If the rinsing liquid can be captured in the painting region 3 of the spray booth 1, it is fed by way of a line 26 to a container 27 and from there passed on by way of a line 28 into the decanter storage container 11.

It follows from the description above that the “water” which is the medium that cleans the air flow in the scrubbing unit 4 is not pure water but is enriched with various chemicals.

In the exemplary embodiment illustrated, the conditioning unit 21 includes four subunits, namely a condenser 29, a droplet separator 30, a heating unit 31 and a further filter 32. The condenser 29 and the droplet separator 30 serve to reduce the moisture content of the recycled recirculating air and the heating unit serves to heat up the recycled recirculating air to the temperature required in the spray booth 1 again, while the filter 32 removes remaining particles from the recycled recirculating air.

The liquids that are removed from the condenser 29 and the droplet separator 30 are jointly called “condensate” below for the sake of simplicity, although strictly speaking only one of the two liquids is a true condensate. They pass by way of a line 33 first of all into a condensate storage container 34. A line 35 connects overflow from the condensate storage container 34 to the system tank 9, with the result that if too much condensate is produced it can be returned directly to the cycle of water flowing through the scrubbing unit 4.

If the overflow level is not reached, the condensate collecting in the condensate storage container 34 first of all passes by way of a line 36 into a bag filter 37, in which any particles therein are removed, and then passes by way of a line 38 into a test station 39. In this test station 39, the condensate is investigated to determine whether its re-use could possibly give rise to disruptions to paint wetting or other problems. For this purpose, among other things a test of the conductivity, the refractive index and the turbidity of the condensate is carried out. Where appropriate, a sample batch may also be taken here and investigated to determine the cause of disruptions to paint wetting. If these tests prove negative—that is to say if the condensate is unsuitable for re-use—it is fed by way of a line 40 to a storage container 41. The condensate collecting here may still be used as the cleaning liquid for the system. However, it is removed from the cycle.

If the test determines that the condensate is suitable for re-use, the latter is fed by way of lines 42, 43 selectively to one of two storage containers 44 and 45. If too much condensate is produced, with the result that it can no longer be accommodated in the storage containers 44 and 45, it is also guided by way of the line 48 into the storage container 41 for cleaning liquid. While one of the two storage containers 44, 45 is being filled, for example the storage container 44, condensate from the other storage container—in the example the one with the reference numeral 45—is put into the preparation vessel 24 of the rinsing liquid supply source, by way of the line 49, and where appropriate is brought up to the required concentration with aqueous rinsing condensate from the reserve container 25.

It can be seen from the description above that, as a result of the recovery of the constituents of the recirculating air leaving the scrubbing unit 4 of the spray booth 1 that are condensable and in droplet form, there is an advantage not only for the water management of the painting system—that is to say the consumption of fresh water may be reduced—but moreover it is possible to keep the consumption of chemicals low, since some of the chemicals that hitherto overflowed with the condensate into the water flowing through the scrubbing unit 4 and were hence lost can be recovered.

1. A painting system which operates in recirculating air mode
a) a spray booth which, from the top downwards, includes:
aa) an air plenum to which conditioned recirculating air may be fed;
ab) a painting region in which at least one application device for applying paint is provided and through which recirculating air flows and in so doing takes up and carries along particles of paint overspray;
ac) a scrubbing unit in which the recirculating air coming from the painting region and laden with the particles of paint overspray interacts with a stream of water and in so doing is at least partly freed of the particles of paint overspray;
b) a conditioning unit which lies in a circulation path of the recirculating air and which includes at least a condenser and/or a droplet separator, wherein liquid obtained from the condenser and/or the droplet separator is returned to the painting region;
c) a supply source for rinsing liquid which is fed to the application device for cleaning; and,
d) wherein at least some of the liquid obtained from the condenser and/or the droplet separator is fed to the supply source for rinsing liquid.

2. The painting system according to claim 1, wherein the supply source for rinsing liquid includes a preparation vessel to which the liquid obtained from the condenser and/or the droplet separator is fed, and a reserve container for an aqueous rinsing concentrate.

3. The painting system according to claim 1, wherein a filter is provided through which the liquid obtained from the condenser and/or the droplet separator flows.

4. The painting system according to claim 1, wherein a test station is provided which, by measuring a conductivity and/or a refractive index and/or a turbidity of the liquid obtained from the condenser and/or the droplet separator, checks its suitability for re-use in the rinsing liquid, and wherein unsuitable liquid is guided to a reserve container.

5. The painting system according to claim 1, wherein at least two parallel storage containers are provided, in which the liquid coming from the condenser and/or the droplet separator is selectively temporarily stored before it is fed to the supply source for rinsing liquid.
